(19) United States
(12) Patent Application Publication
(10) Pub. No.: US 2018/0019606 A1
(43) Pub. Date: Jan. 18, 2018

(54) BATTERY CELL BALANCING CIRCUIT USING SINGLE INDUCTOR

(71) Applicant: POSTECH ACADEMY-INDUSTRY FOUNDATION, Pohang-si (KR)

(72) Inventors: Bong Koo KANG, Pohang-si (KR); Sang Won LEE, Daejeon-si (KR); Kyung Min LEE, Sejong-si (KR); Yoon Geol CHOI, Seoul (KR)

(21) Appl. No.: 15/649,563

(22) Filed: Jul. 13, 2017

(30) Foreign Application Priority Data
Jul. 15, 2016 (KR) 10-2016-0089630

(51) Int. Cl. H02J 7/00

(52) U.S. Cl. CPC H02J 7/0054

(57) ABSTRACT

The present invention relates to a battery cell balancing circuit for balancing battery cells of a battery pack using a single inductor.

The battery cell balancing circuit includes a first access unit, a second access unit and an electrical energy transfer unit for an electrical energy path of a battery pack. The battery cell balancing circuit selectively connects a strong cell or weak cell of the battery pack to a single inductor by controlling switching operations of switches of the first and second access units and the electrical energy transfer unit, thereby performing battery cell balancing. Thus, the power efficiency of the battery pack can be improved, and the size and price thereof can be reduced.

### BACKGROUND

### 1. Technical Field

The present disclosure relates to a technique for balancing battery cells of a battery pack using a single inductor, and more particularly, to a battery cell balancing circuit using a single inductor, which can be easily expanded according to the number of battery cells while exhibiting excellent power efficiency.

### 2. Related Art

In general, when the voltage across a battery (battery cell) exceeds a predetermined value, an explosion hazard exists. On the other hand, when the voltage falls below a predetermined value, the battery cell may be permanently damaged. A hybrid electric vehicle or notebook computer requires a large capacity power supply. Therefore, when power is intended to be supplied through a battery cell, a battery pack (battery module) using battery cells connected in series is used. However, when such a battery pack is used, a voltage imbalance may occur due to performance differences among the battery cells.

For example, when one battery cell in the battery pack reaches the upper limit voltage before the other battery cells when the battery pack is charged, the battery pack cannot be charged any more. Thus, the charging must be finished even though the other battery cells are not sufficiently charged. In this case, the charge capacity of the battery pack does not reach the rated charge capacity.

When the battery pack is discharged, one battery cell in the battery pack may reach the lower limit voltage before the other battery cells. In this case, since the battery pack cannot be used any more, the use time of the battery pack is shortened.

Therefore, when the battery pack is charged or discharged, the electrical energy of a battery cell having higher electrical energy may be supplied to another battery cell having lower electrical energy, which makes it possible to extend the use time of the battery pack. Such an operation is referred to as battery cell balancing.

FIG. 1 illustrates a conventional battery cell balancing circuit using parallel resistors. As illustrated in FIG. 1, the battery cell balancing circuit includes a battery pack 11 including battery cells CELL1 to CELL4 connected in series, resistors R11 to R14 connected in series, and switches SW11 to S15 for selectively connecting arbitrary terminals of the battery cells CELL1 to CELL4 to the corresponding terminals of the resistors R11 to R14.

Referring to FIG. 1, when a charge voltage of an arbitrary battery cell among the battery cells CELL1 to CELL4 of the battery pack 11 reaches the upper limit voltage before charge voltages of the other battery cells while the battery pack 11 is charged, the corresponding switches among the switches SW11 to SW15 are turned on to discharge the arbitrary battery cell through the corresponding resistor among the resistors R11 to R14.

For example, when the charge voltage of the second battery cell CELL2 reaches the upper limit voltage before the charge voltages of the other battery cells CELL1, CELL3 and CELL4, the switches SW12 and SW13 are turned on. Then, while the battery cell CELL2 is charged through the resistor R12, battery cell balancing is achieved.

However, when such a battery cell balancing circuit is used, power is consumed through the resistors. Therefore, the efficiency of the battery cell balancing circuit is reduced. Furthermore, when the upper limit voltage cannot be supplied to a battery cell having a low voltage while the battery pack is used, the efficiency is reduced.

FIG. 2 illustrates another conventional battery cell balancing circuit using capacitors. As illustrated in FIG. 2, the battery cell balancing circuit includes a battery pack 21 having battery cells CELL1 to CELL4 connected in series, capacitors C21 to C23 connected in series, and switches SW21 to SW24 for selectively connecting both terminals of an arbitrary capacitor among the capacitors C21 to C23 to the corresponding both terminals among both terminals of the respective battery cells CELL1 to CELL4.

Referring to FIG. 2, the battery cell balancing circuit using the capacitors has two kinds of connection states. In the first connection state as illustrated in FIG. 2, one terminal of the capacitor C21, a connection terminal between the capacitors C21 and C22, a connection terminal between the capacitors C22 and C23, and the other terminal of the capacitor C23 are coupled to one terminals (positive terminals) of the respective battery cells CELL1 to CELL4. In the second connection state, the one terminal of the capacitor C21, the connection terminal between the capacitors C21 and C22, the connection terminal between the capacitors C22 and C23, and the other terminal of the capacitor C23 are coupled to the other terminals (negative terminals) of the respective battery cells CELL1 to CELL4.

In such a battery cell balancing circuit, however, a hard switching operation is performed between a capacitor and a battery cell, thereby lowering the efficiency. It is desirable that the battery cells in the battery pack have the same capacity. However, the battery cells have different capacities from each other due to various reasons. In this case, although a charge voltage of a battery cell is lower than charge voltages of the other battery cells, the battery cell may have a larger capacity. Thus, the voltage of the battery cell having a lower voltage needs to be transferred to another battery cell having a high voltage. However, the conventional battery cell balancing circuit cannot perform the voltage transfer function.

FIG. 3 illustrates another conventional battery cell balancing circuit using a flyback architecture. As illustrated in FIG. 3, the battery cell balancing circuit includes a battery pack 31 having battery cells CELL1 to CELL4 connected in series, a flyback converter 32, switches SW31 to SW34 for selectively connecting a plurality of secondary coils of the flyback converter 32 to both terminals of the respective battery cells CELL1 to CELL4, and a switch SW35 for selectively connecting both ends of a primary coil of the flyback converter 32 to both terminals of the battery pack 31.

The battery cell balancing circuit of FIG. 3 is a battery cell balancing circuit using a flyback architecture which is one of switch modes power supplies (SMPS), and has an architecture capable of transferring electrical energy to the battery cells CELL1 to CELL4 connected in series in the battery pack 31 using the switches SW31 to SW34, and transferring electrical energy between both terminals of the battery pack 31.

Since the battery cell balancing circuit has a flyback architecture based on the SMPS, the battery cell balancing circuit exhibits excellent efficiency. However, as the number of battery cells installed in the battery pack is increased, the size of a magnetic core used in the flyback converter is inevitably increased, thereby raising the price of the battery cell balancing circuit.

### SUMMARY

Various embodiments are directed to a battery cell balancing circuit using a single inductor, which is capable of performing battery cell balancing using the single inductor.

Also, various embodiments are directed to a battery cell balancing circuit using a single inductor, which is capable of transferring balancing energy through the single inductor, thereby reducing the cost and size thereof.

In an embodiment, a battery cell balancing circuit using a single inductor may include: a battery pack having a plurality of battery cells connected in series; a first access unit having access paths connected between a first common node and negative terminals of odd-numbered battery cells in the battery pack; a second access unit having access paths connected between a second common node and negative terminals of even-numbered battery cells in the battery pack; and an electrical energy transfer unit having a single inductor and a plurality of transfer paths, in order to temporarily store electrical energy collected or supplied through the first and second common nodes and then transfer the stored electrical energy.

### BRIEF DESCRIPTION OF THE DRAWINGS

FIG. 1 illustrates a conventional battery cell balancing circuit using parallel resistors.

FIG. 2 illustrates another conventional battery cell balancing circuit using capacitors.

FIG. 3 illustrates another conventional battery cell balancing circuit using a flyback architecture.

FIG. 4 illustrates a battery cell balancing circuit using a single inductor according to an embodiment of the present invention.

FIG. 5 is a table showing switch states in four kinds of cell access modes according to the embodiment of the present invention.

FIGS. 6a to 6c are circuit diagrams illustrating paths for transferring electrical energy stored in an odd-numbered strong cell to an even-numbered weak cell, and current flows.

FIG. 7 is a waveform diagram of units of FIG. 4 when electrical energy stored in an odd-numbered strong cell is transferred to an even-numbered weak cell.

FIGS. 8a to 8c are circuit diagrams illustrating paths for transferring electrical energy stored in an even-numbered strong cell to an odd-numbered weak cell, and current flows.

FIG. 9 is a waveform diagram of units of FIG. 4 when electrical energy stored in an even-numbered strong cell is transferred to an odd-numbered weak cell.

FIGS. 10a to 10c are circuit diagrams illustrating paths for transferring electrical energy stored in an even-numbered strong cell to another even-numbered weak cell, and current flows.

FIG. 11 is a waveform diagram of units of FIG. 4 when electrical energy stored in an even-numbered strong cell is transferred to an even-numbered weak cell.

FIGS. 12a to 12c are circuit diagrams illustrating paths for transferring electrical energy stored in an odd-numbered strong cell to another odd-numbered weak cell, and current flows.

FIG. 13 is a waveform diagram of units in FIG. 4 when electrical energy stored in an odd number of strong cells is transferred to an odd number of weak cells.

FIG. 14 is a waveform diagram illustrating test results of the battery cell balancing circuit according to the embodiment of the present invention.

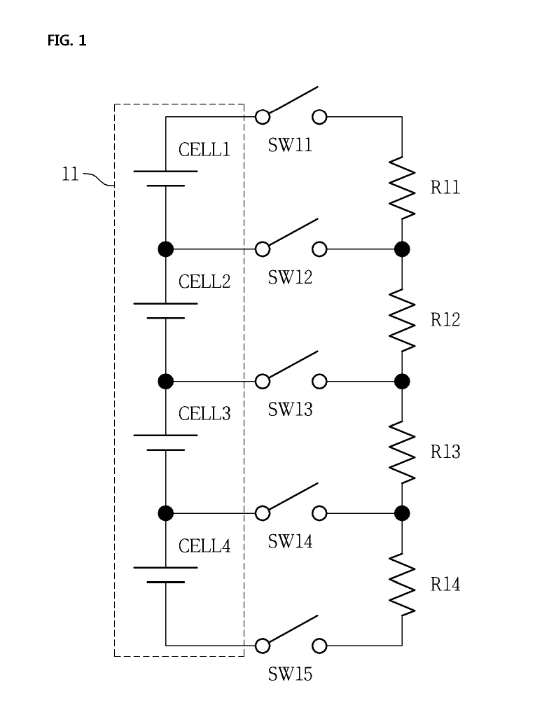

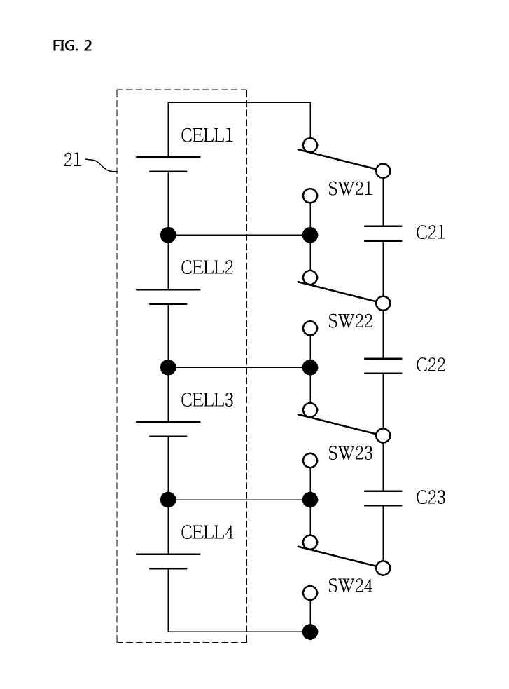

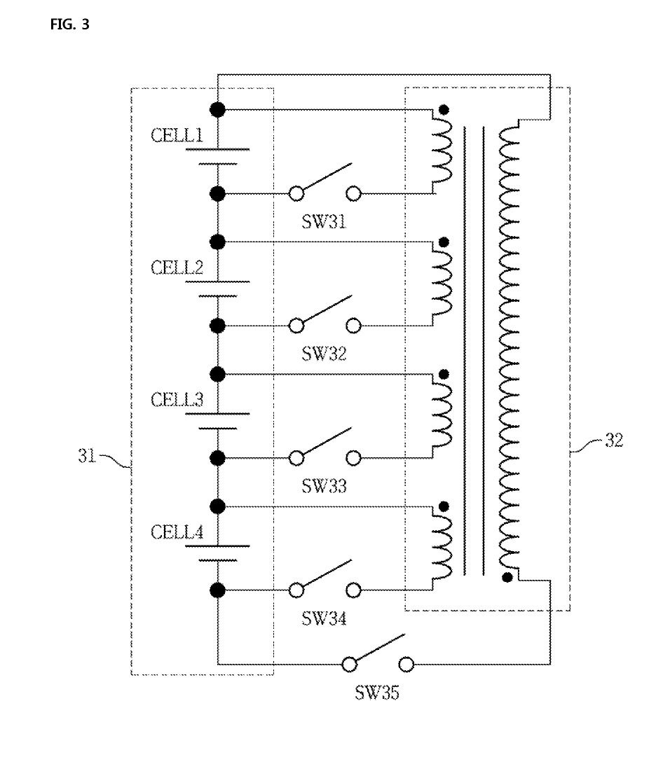

### DETAILED DESCRIPTION

Hereafter, various embodiments of the present invention will be described in detail with reference to the accompanying drawings.

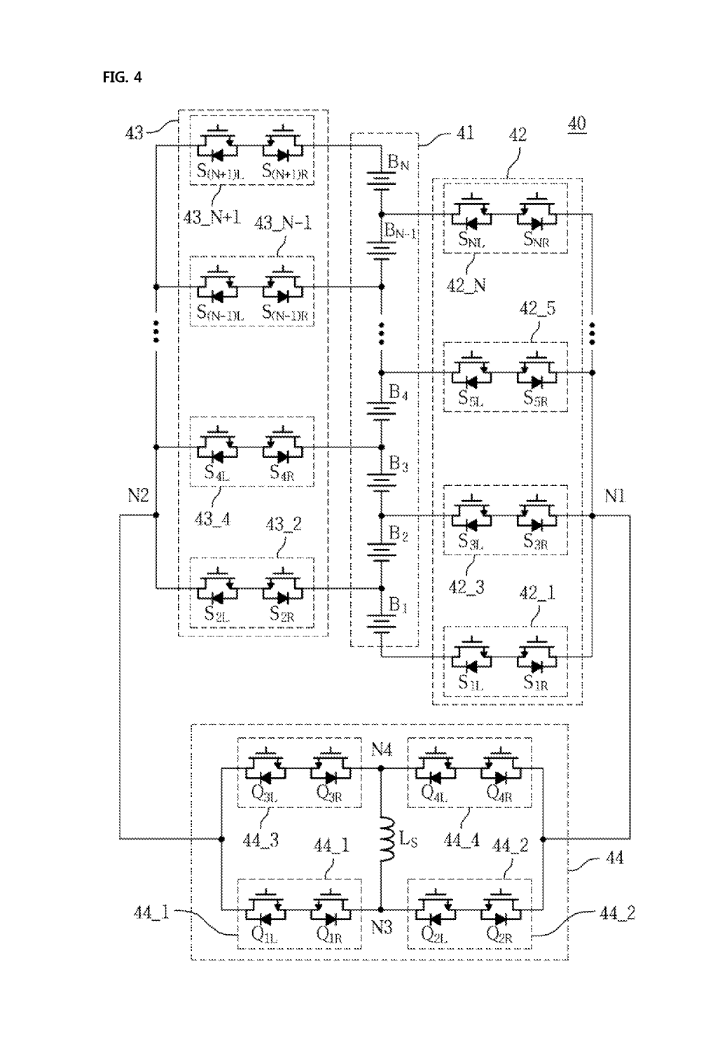

FIG. 4 illustrates a battery cell balancing circuit using a single inductor according to an embodiment of the present invention. As illustrated in FIG. 4, the battery cell balancing circuit 40 includes a battery pack 41, a first access unit 42, a second access unit 43 and an electrical energy transfer unit 44.

The battery pack 41 includes battery cells B₁ to B_{N} connected in series, and stores electrical energy supplied from outside. Although a voltage imbalance may occur due to performance differences among the battery cells B₁ to B_{N}, the voltage imbalance is removed by a battery cell balancing operation which will be described later.

The first access unit 42 includes odd-numbered access paths coupled between a first common node N1 and negative terminals (“−” terminal) of odd-numbered battery cells among the battery cells B₁ to B_{N} installed in the battery pack 41, respectively. Each of the odd-numbered access paths includes a pair of switches connected in series. Among the odd-numbered access paths, a first access path 42_1 includes a pair of switches S_{1L} and S_{1R} connected in series, a third access path 42_3 includes a pair of switches S_{3L} and S_{3R} connected in series, a fifth access path 42_5 includes a pair of switches S_{5L} and S_{5R} connected in series, and an Nth access path 42_N includes a pair of switches S_{NL} and S_{NR} connected in series.

The second access unit 43 includes even-numbered access paths connected between a second common node N2 and negative terminals (“−” terminal) of even-numbered battery cells among the battery cells B₁ to B_{N} installed in the battery pack 41, respectively. Each of the even-numbered access paths includes a pair of switches connected in series. Among the even-numbered access paths, a second access path 43_2 includes a pair of switches S_{2L} and S_{2R} connected in series, a fourth access path 43_4 includes a pair of switches S_{4L} and S_{4R} connected in series, an (N−1)th access path 43_6 includes a pair of switches S_{(N-1)L} and S_{(N-1)R} connected in series, and an (N+1)th access path 43_N+1 includes a pair of switches S_{(N+1)L} and S_{(N+1)R} connected in series.

The electrical energy transfer unit 44 includes four transfer paths 44_1 to 44_4 and an inductor Ls, in order to transfer electrical energy which is collected or released through the first and second common nodes N1 and N2.

Among the four transfer paths, the first transfer path 44_1 includes a pair of switches Q_{1L} and Q_{1R} connected in series between the second common node N2 and a third common node N3, the second transfer path 44_2 includes a pair of switches Q_{2L} and Q_{2R} connected in series between the first common node N1 and the third common node N3, the third transfer path 44_3 includes a pair of switches Q_{3L} and Q_{3R} connected in series between the second common node N2 and a fourth common node N4, and the fourth transfer path 44_4 includes a pair of switches Q_{4L} and Q_{4R} connected in series between the first common node N1 and the fourth common node N4.

The inductor Ls is a single inductor serving as an electrical energy transfer medium, and serves to temporarily store electrical energy collected from the battery pack 41 and release the stored electrical energy, in order to perform battery balancing on the battery pack 41. For this operation, the inductor Ls is connected between the fourth common node N4 and the third common node N3.

In FIG. 4, the switches S of the first and second access units 42 and 43 and the switch Q of the electrical energy transfer unit 44 are implemented with metal oxide semiconductor field effect transistors (MOSFET). In FIG. 4, ‘L’ represents a switch located at the left, and ‘R’ represents a switch at the right. The switches applied to the present embodiment are not limited to MOS transistors, but may include power switches such as bipolar junction transistors (BJT) and insulated gate bipolar transistors (IGBT). Each of the MOS transistors is connected in parallel to a diode.

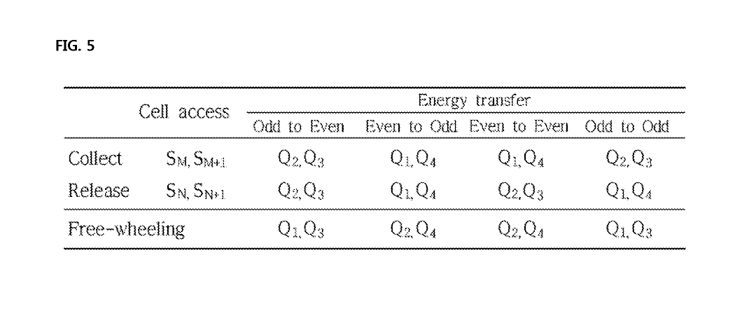

The battery cell balancing circuit 40 operates in four kinds of cell access modes, and each of the four kinds of cell access modes includes three kinds of driving modes (driving periods). FIG. 5 shows the states of the switches S of the first and second access units 42 and 43 and the switches Q of the electrical energy transfer unit 44 in the four kinds of cell access modes. In FIG. 5, a collect mode refers to a mode for collecting electrical energy from a strong cell which has relatively high electrical energy and releases electrical energy, and a release mode refers to a mode for supplying electrical energy, which is collected through the collect mode and temporarily stored in the inductor Ls, to a weak cell having relatively low electrical energy.

The four kinds of cell access modes are classified into odd/even, even/odd, even/even and odd/odd modes, depending on the parities of a strong cell and a weak cell between two battery cells selected as the target of a battery cell balancing operation, when the battery cell balancing operation is performed on the battery cells B₁ to B_{N} included in the battery pack 41.

The battery cell balancing path according to the present embodiment may be divided into two kinds of paths having different electrical energy flow paths. One path of the two kinds of paths corresponds to the case in which a strong cell and a weak cell have different parities from each other, that is, the odd/even or even/odd mode (hereafter, referred to as “different-parity path”). In the battery cell balancing mode using the different-parity path, electrical energy collected from the storing cell is stored in the inductor Ls and then supplied to the weak cell. The other path of the two kinds of paths corresponds to the case in which a strong cell and a weak cell have the same parity, that is, the odd/odd or even/even mode (hereafter, referred to as “same-parity path”). In the battery cell balancing mode using the same-parity path, electrical energy collected from the storing cell is stored in the inductor Ls and then supplied to the weak cell.

For reference, S_{M} and S_{M+1} in Cell access of FIG. 5 represent switches for accessing an Mth storing cell. For example, when the second battery cell B₂ is a strong cell, the switches S_{2L} and S_{2R} correspond to SM, and the switches S_{3L} and S_{3R} correspond to SM+1. In addition, S_{N} and S_{N+1} represent switches for accessing an Nth weak cell. For example, when the fourth battery cell B₄ is a weak cell, the switches S_{4L} and S_{4R} correspond to S_{N}, and the switches S_{5L} and S_{5R} correspond to S_{N+1}.

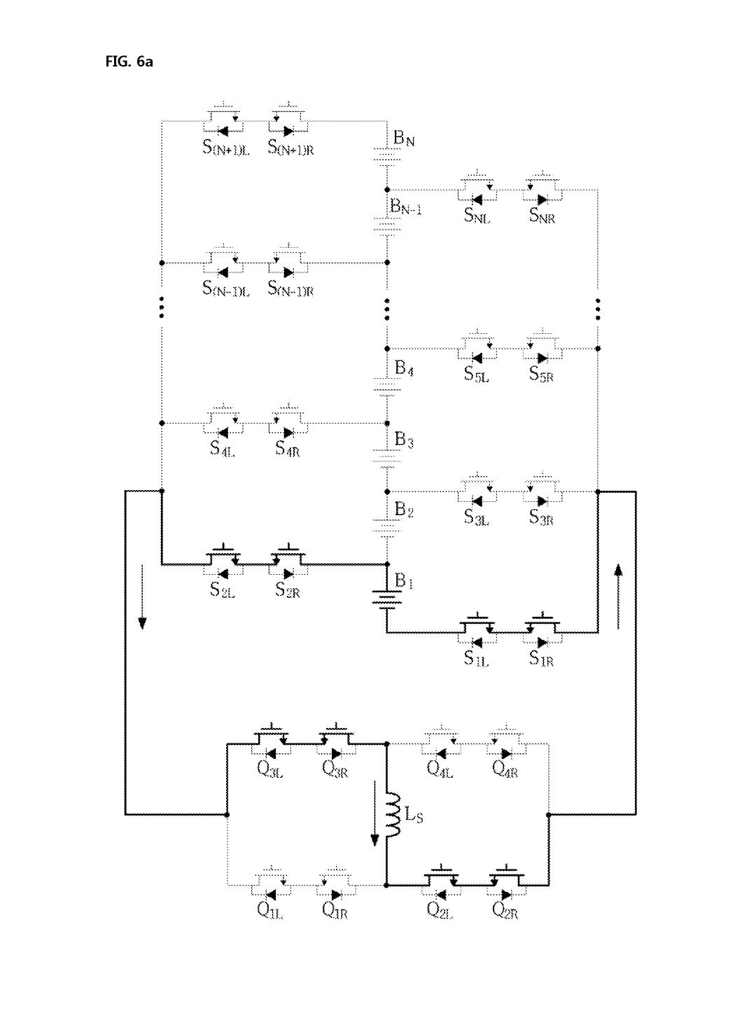

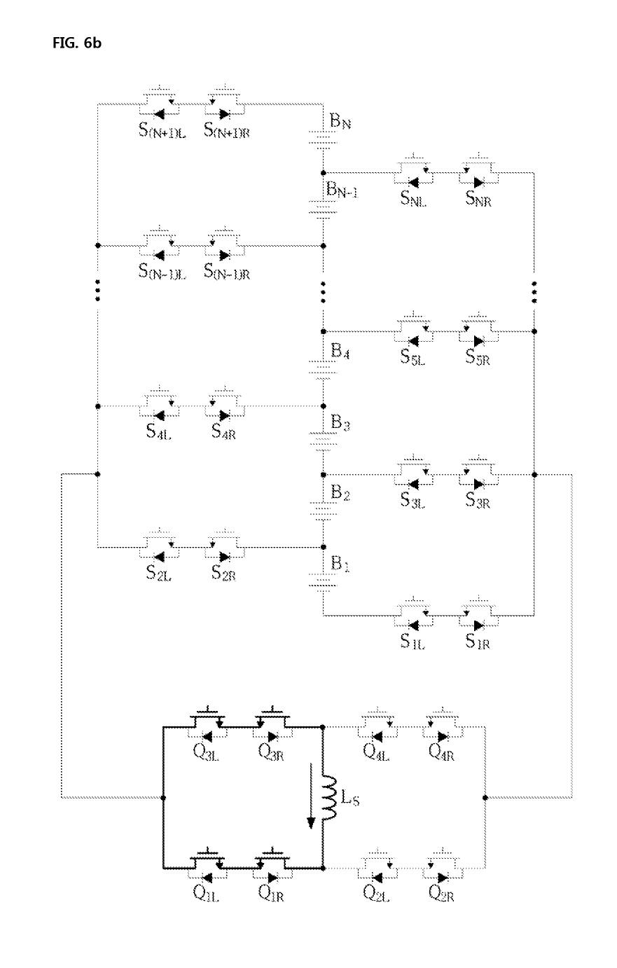

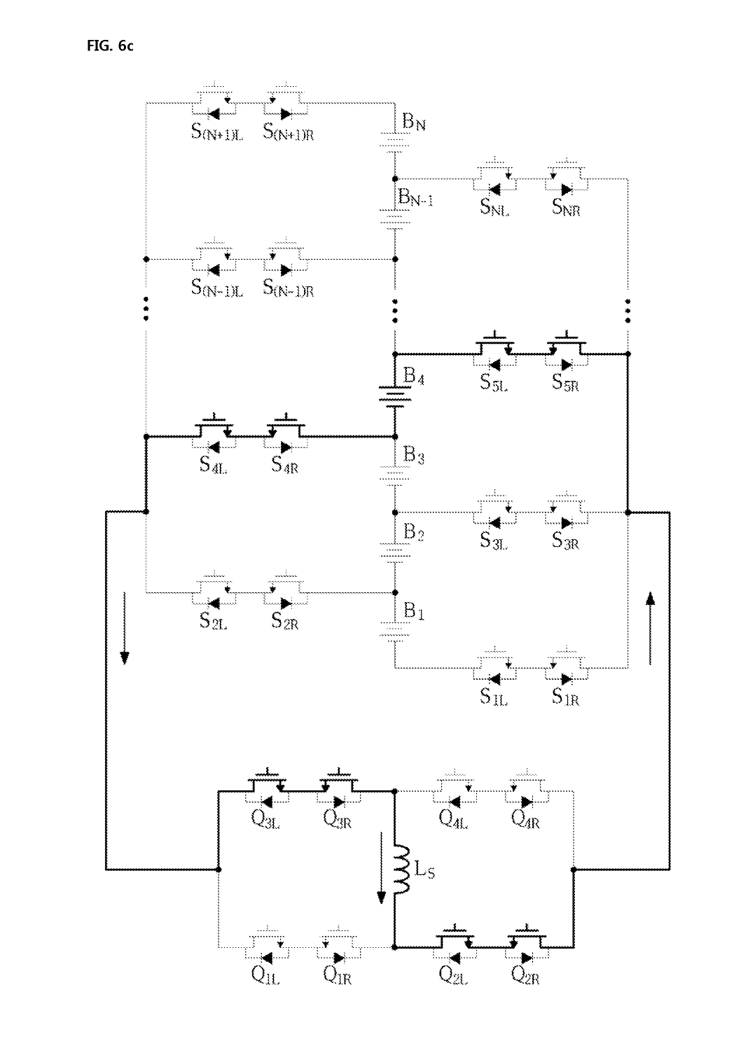

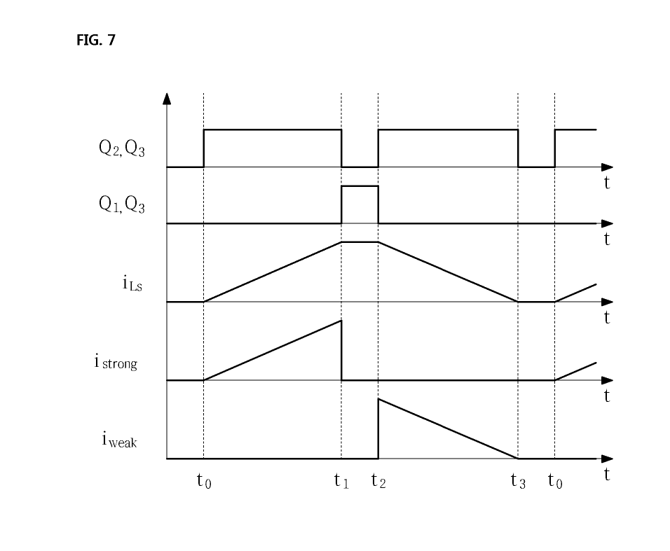

First, referring to FIGS. 6A to 6C and 7, a battery cell balancing operation using the different-parity path for supplying electrical energy stored in an odd-numbered battery cell to an even-numbered battery cell will be described as follows. The following descriptions will be based on the supposition that the odd-numbered battery cell B₁ is a strong cell and the even-numbered battery cell B₄ is a weak cell.

In a first mode t₀-t₁, a control unit (not illustrated) turns on the switches S_{1L} and S_{1R} of the first access unit 42, the switches S_{2L} and S_{2R} of the second access unit 43, and the switches Q_{2L} and Q_{2R} and Q_{3L} and Q_{3R} of the electrical energy transfer unit 44 by outputting a switch control signal (gate signal) to the switches. Thus, as illustrated in FIG. 6A, the positive terminal (+) of the battery cell B₁ is connected to one side of the inductor Ls through the switches S_{2L} and S_{2R} and Q_{3L} and Q_{3R}, and the negative terminal (−) of the battery cell B₁ is connected to the other side of the inductor Ls through the switches S_{1L} and S_{1R} and Q_{2L} and Q_{2R}. Therefore, the electrical energy of the battery cell B₁ is transferred and stored into the inductor Ls.

When the weak cell is connected to the inductor Ls through the switches in the release mode after the strong cell is connected to the inductor Ls through the switches in the collect mode, a dead time is needed between the collect mode and the release mode.

A second mode t₁-t₂ is a mode for forming an electrical energy circulation path during the dead time. For this operation, the control unit turns on the switches Q_{1L} and Q_{1R} and Q_{3L} and Q_{3L} of the electrical energy transfer unit 44. Therefore, as illustrated in FIG. 6B, the collected electrical energy free wheels in a closed loop including the switches S_{1L} and S_{1R} and Q_{3L} and Q_{3R} and the inductor Ls during the dead time.

A third mode t₂-t₃ is a mode for transferring the collected electrical energy to the battery cell B₄ serving as the weak cell. For this operation, the control unit turns on the switches S_{5L} and S_{5R} of the first access unit 42, the switches S_{4L} and S_{4R} of the second access unit 43, and the switches Q_{2L} and Q_{2R} and Q_{3L} and Q_{3R} of the electrical energy transfer unit 44 by outputting the switch control signal to the switches. Thus, as illustrated in FIG. 6C, the electrical energy stored in the inductor Ls is transferred to the battery cell B₄ through the switches Q_{2L} and Q_{2R} and S_{5L} and S_{5R}.

While the first to third modes are repeated within one preset period, the voltage levels of the strong cell B₁ and the weak cell B₄ are equalized to each other.

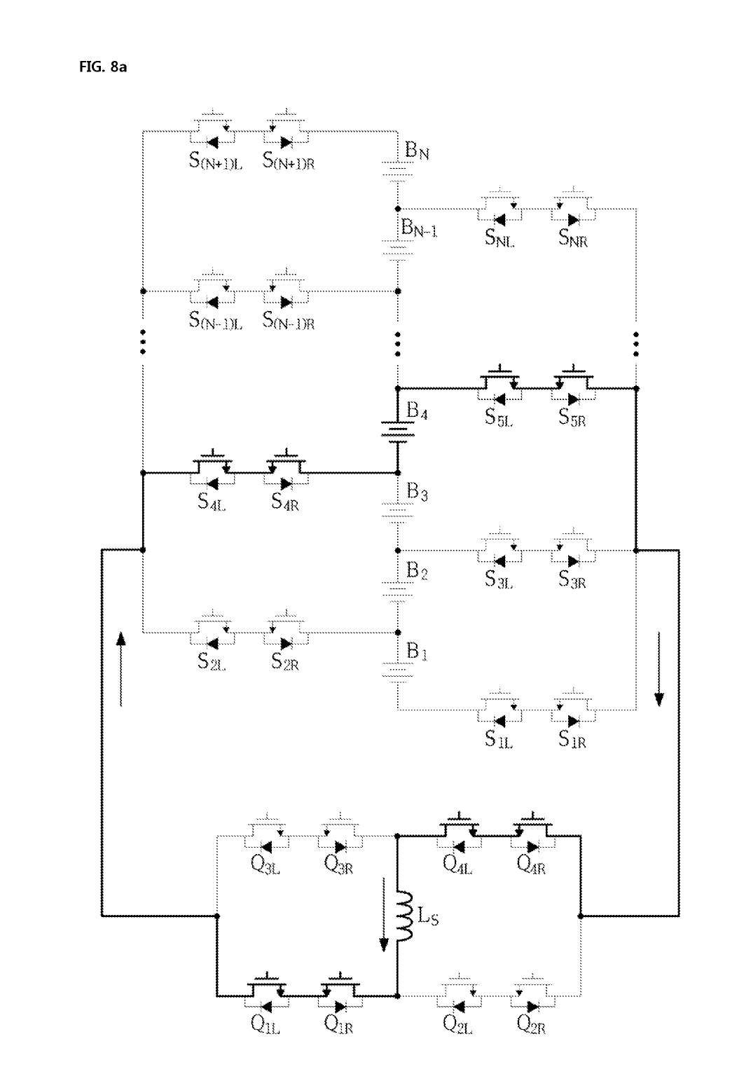

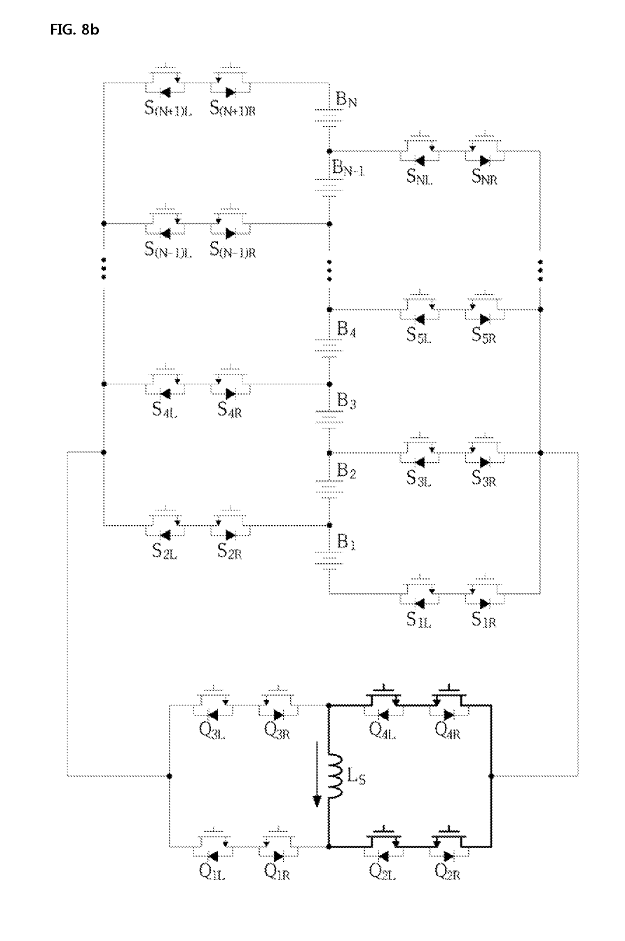

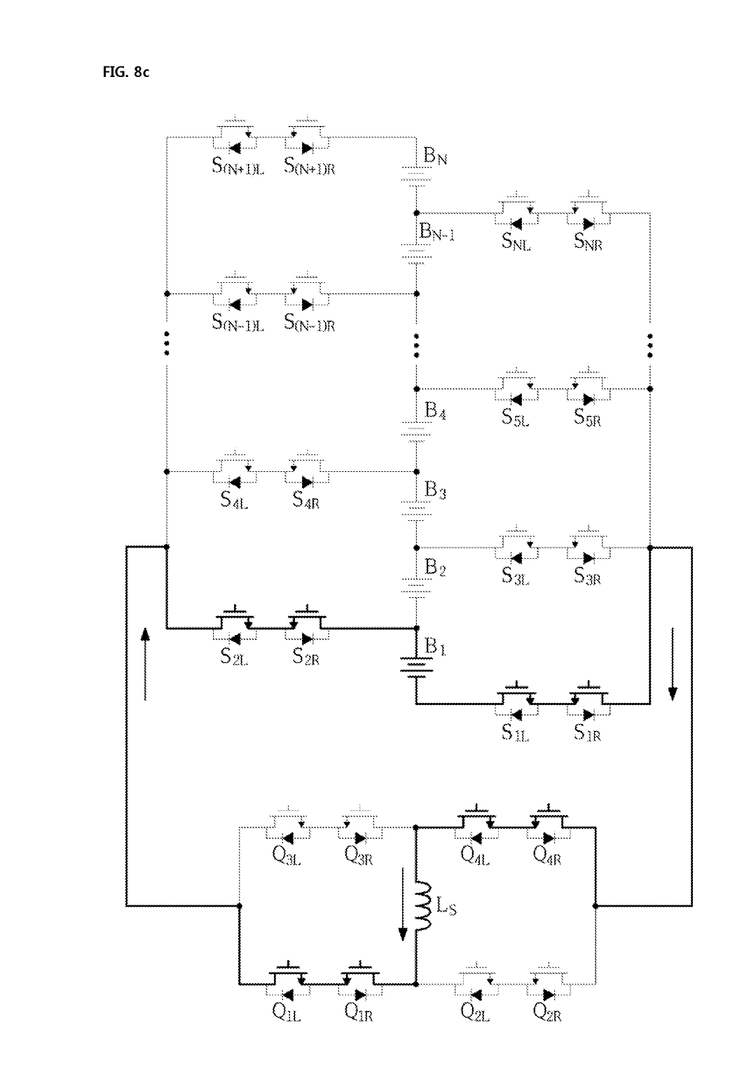

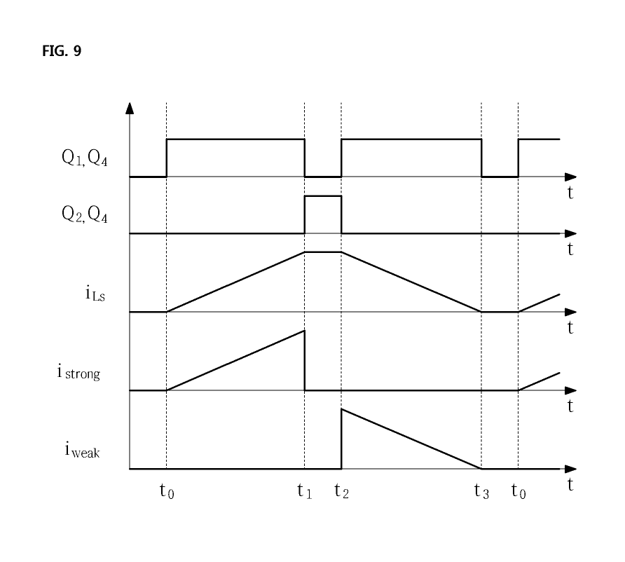

Second, referring to FIGS. 8A to 8C and 9, a battery cell balancing operation using the different-parity path for supplying electrical energy stored in an even-numbered battery cell to an odd-numbered battery cell will be described as follows. The following descriptions will be based on the supposition that the even-numbered battery cell B₄ is a strong cell and the odd-numbered battery cell B₁ is a weak cell.

In the first mode t₀-t₁, the control unit turns on the switches S_{5L} and S_{5R} of the first access unit 42, the switches S_{4L} and S_{4R} of the second access unit 43, and the switches Q_{1L} and Q_{1R} and Q_{4L} and Q_{4R} of the electrical energy transfer unit 44 by outputting the switch control signal (gate signal) to the switches. Thus, as illustrated in FIG. 8A, the positive terminal (+) of the battery cell B₄ is coupled to one side of the inductor Ls through the switches S_{5L} and S_{5R} and Q_{4L} and Q_{4R}, and the negative terminal (−) of the battery cell B₄ is coupled to the other side of the inductor Ls through the switches S_{4L} and S_{4R} and Q_{1L} and Q_{1R}. Therefore, the electrical energy of the battery cell B₄ is transferred and stored into the inductor Ls.

When the weak cell is connected to the inductor Ls through the switches in the release mode after the strong cell is connected to the inductor Ls through the switches in the collect mode, a dead time is needed between the collect mode and the release mode.

The second mode t₁-t₂ is a mode for forming an electrical energy circulation path during the dead time. For this operation, the control unit turns on the switches Q_{2L} and Q_{2R} and Q_{4L} and Q_{4R} of the electrical energy transfer unit 44. Therefore, as illustrated in FIG. 8B, the collected electrical energy free wheels in a closed loop including the switches Q_{2L} and Q_{2R} and Q_{4L} and Q_{4R} and the inductor Ls during the dead time.

The third mode t₂-t₃ is a mode for transferring the collected electrical energy to the battery cell B₁ serving as the weak cell. For this operation, the control unit turns on the switches S_{1L} and S_{1R} of the first access unit 42, the switches S_{2L} and S_{2R} of the second access unit 43, and the switches Q_{1L} and Q_{1R} and Q_{4L} and Q_{4R} of the electrical energy transfer unit 44 by outputting the switch control signal to the switches. Thus, as illustrated in FIG. 8C, the electrical energy stored in the inductor Ls is transferred to the battery cell B₁ through the switches Q_{1L} and Q_{1R} and S_{2L} and S_{2R}.

While the first to third modes are repeated within one preset cycle, the voltage levels of the strong cell B₄ and the weak cell B1 are equalized to each other.

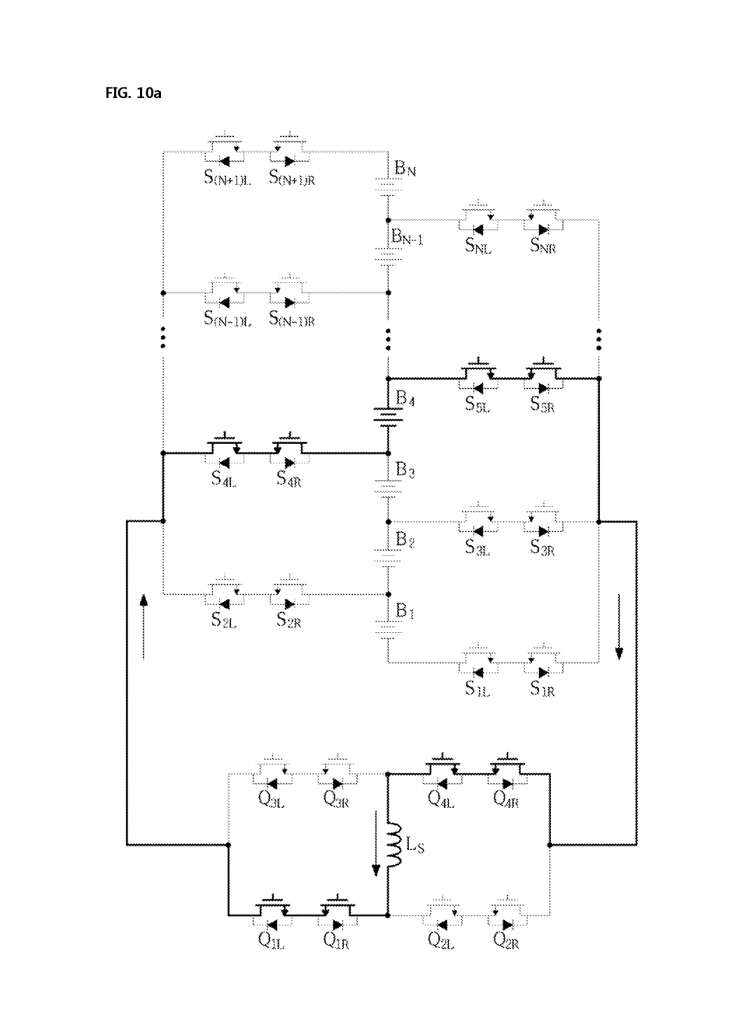

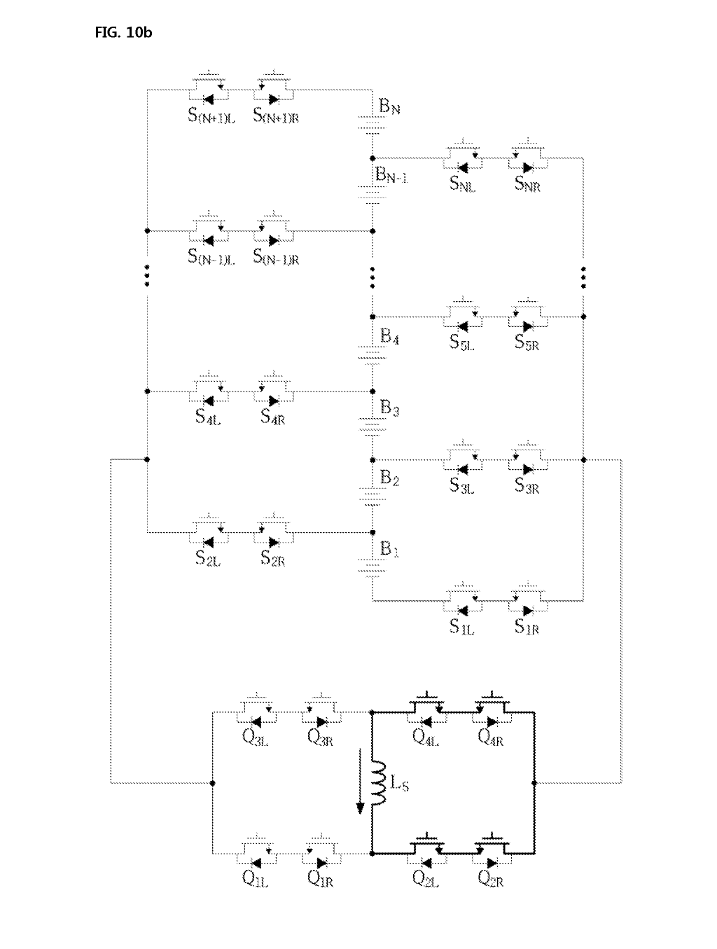

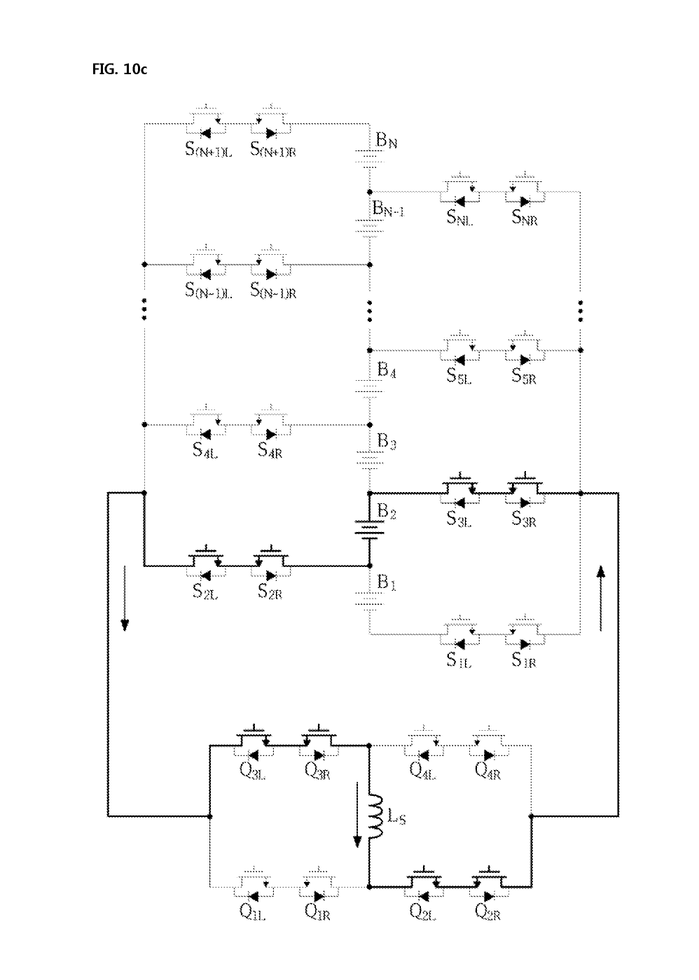

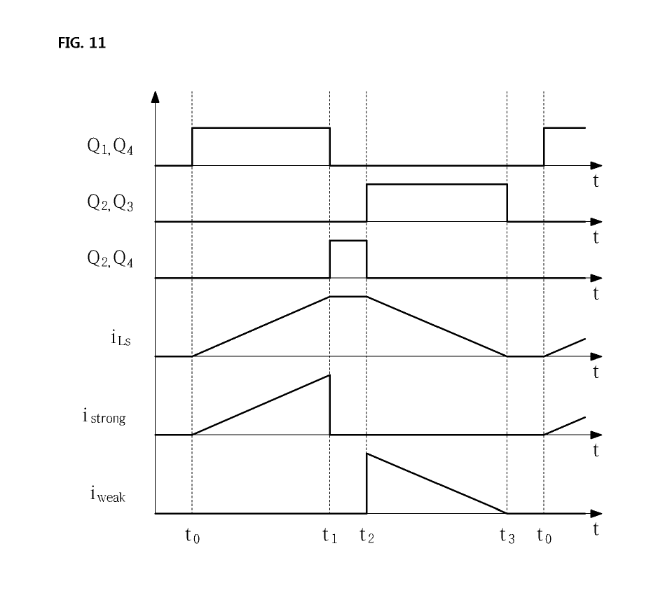

Third, referring to FIGS. 10A to 10C and 11, a battery cell balancing operation using the same-parity path for supplying electrical energy stored in an even-numbered battery cell to another even-numbered battery cell will be described as follows. The following descriptions will be based on the supposition that the even-numbered battery cell B₄ is a strong cell and the even-numbered battery cell B₂ is a weak cell.

In the first mode t₀-t₁, the control unit turns on the switches S_{5L} and S_{5R} of the first access unit 42, the switches S_{4L} and S_{4R} of the second access unit 43, and the switches Q_{1L} and Q_{1R} and Q_{4L} and Q_{4R} of the electrical energy transfer unit 44 by outputting the switch control signal (gate signal) to the switches. Thus, as illustrated in FIG. 10A, the positive terminal (+) of the battery cell B₄ is connected to one side of the inductor Ls through the switches S_{5L} and S_{5R} and Q_{4L} and Q_{4R}, and the negative terminal (−) of the battery cell B₄ is connected to the other side of the inductor Ls through the switches S_{4L} and S_{4R} and Q_{1L} and Q_{1R}. Therefore, the electrical energy of the battery cell B₄ is transferred and stored into the inductor Ls.

When the weak cell is connected to the inductor Ls through the switches in the release mode after the strong cell is connected to the inductor Ls through the switches in the collect mode, a dead time is needed between the collect mode and the release mode.

The second mode t₁-t₂ is a mode for forming an electrical energy circulation path during the dead time. For this operation, the control unit turns on the switches Q_{2L} and Q_{2R} and Q_{4L} and Q_{4R} of the electrical energy transfer unit 44. Therefore, as illustrated in FIG. 10B, the collected electrical energy free wheels in a closed loop including the switches Q_{2L} and Q_{2R} and Q_{4L} and Q_{4R} and the inductor Ls during the dead time.

The third mode t₂-t₃ is a mode for transferring the collected electrical energy to the battery cell B₂ serving as the weak cell. For this operation, the control unit turns on the switches S_{3L} and S_{3R} of the first access unit 42, the switches S_{2L} and S_{2R} of the second access unit 43, and the switches Q_{2L} and Q_{2R} and Q_{3L} and Q_{3R} of the electrical energy transfer unit 44 by outputting the switch control signal to the switches. Thus, as illustrated in FIG. 10C, the electrical energy stored in the inductor Ls is transferred to the battery cell B₂ through the switches Q_{2L} and Q_{2R} and S _{3L} and S_{3R} .

While the first to third modes are repeated within one preset cycle, the voltage levels of the strong cell B₄ and the weak cell B₂ are equalized to each other.

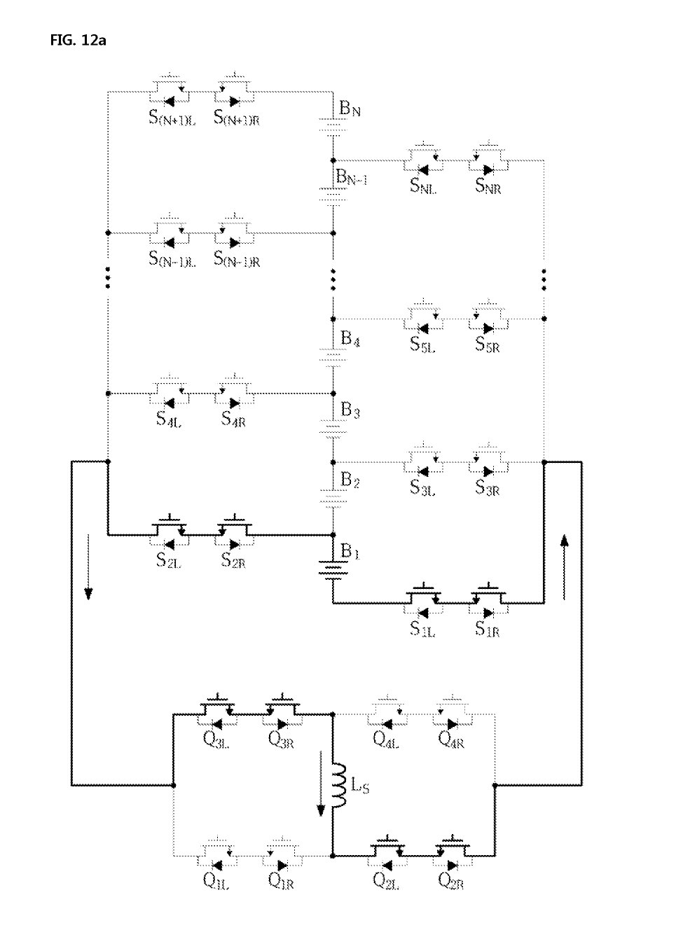

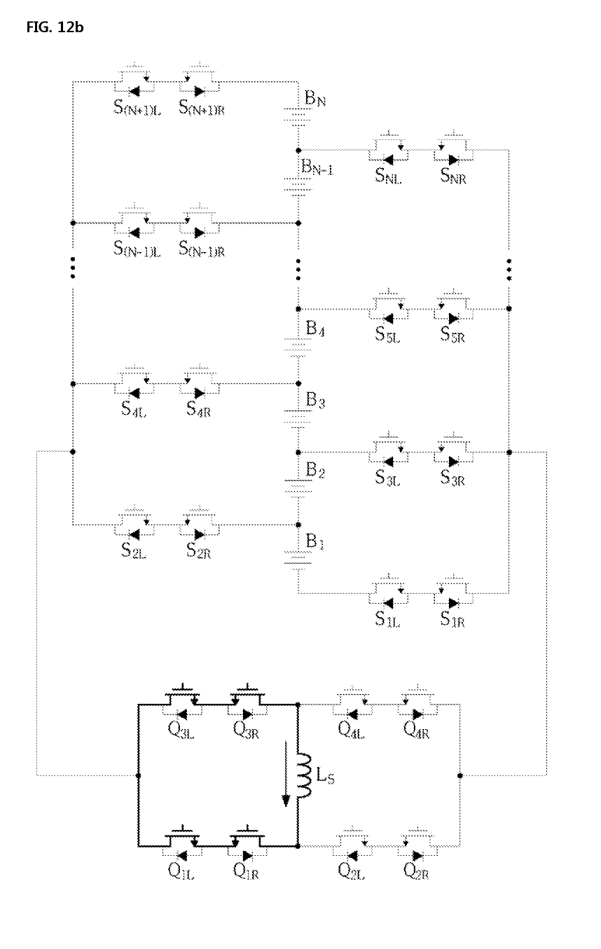

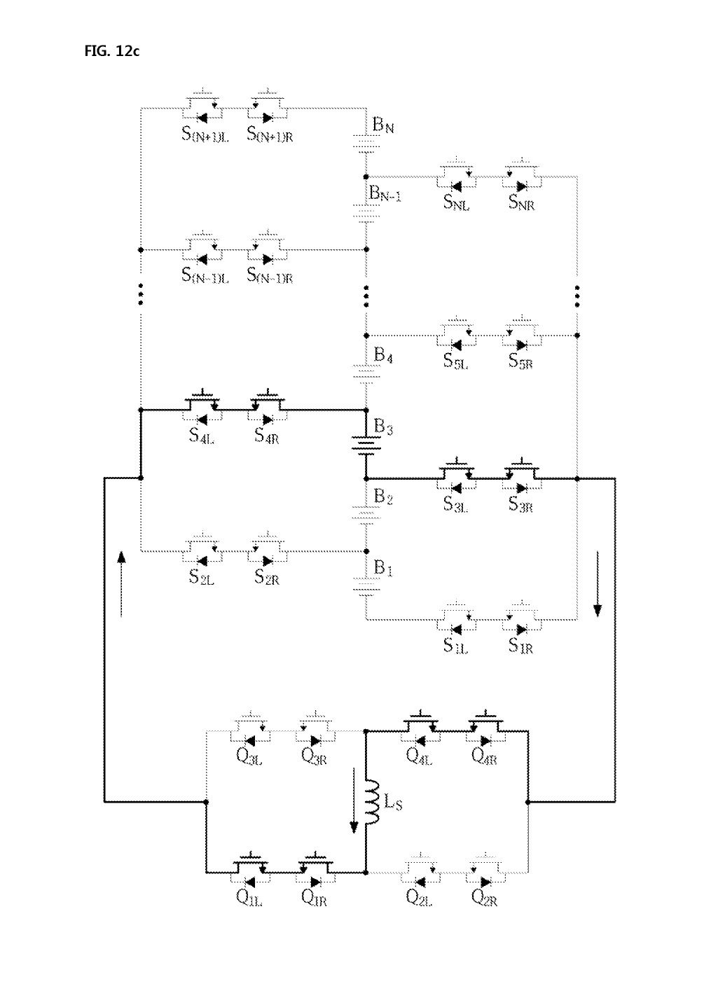

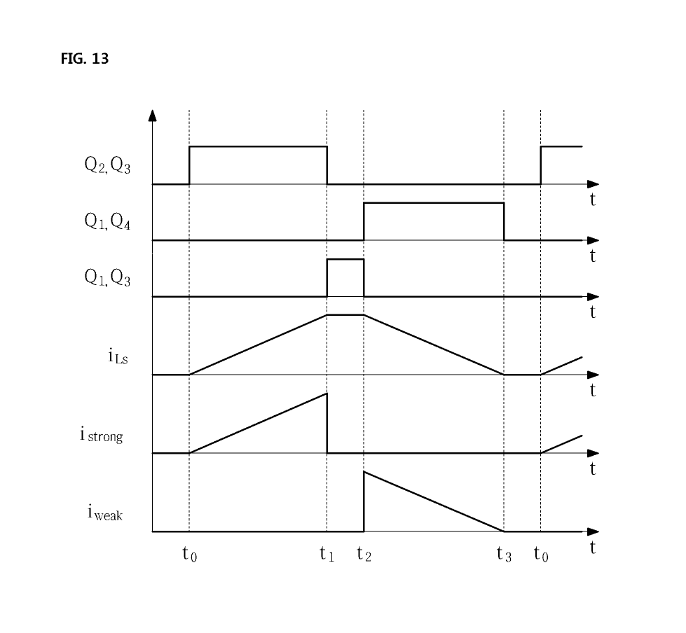

Fourth, referring to FIGS. 12A to 12C and 13, a battery cell balancing operation using the same-parity path for supplying electrical energy stored in an odd-numbered battery cell to another odd-numbered battery cell will be described as follows. The following descriptions will be based on the supposition that the odd-numbered battery cell B₁ is a strong cell and the odd-numbered battery cell B₃ is a weak cell.

In the first mode t₀-t₁, the control unit turns on the switches S_{1L} and S_{1R} of the first access unit 42, the switches S_{2L} and S_{2R} of the second access unit 43, and the switches Q_{2L} and Q_{2R} and Q_{3L} and Q_{3R} of the electrical energy transfer unit 44 by outputting the switch control signal (gate signal) to the switches. Thus, as illustrated in FIG. 12A, the positive terminal (+) of the battery cell B₁ is connected to one side of the inductor Ls through the switches S_{2L} and S_{2R} and Q_{3L} and Q_{3R}, and the negative terminal (−) of the battery cell B₁ is connected to the other side of the inductor Ls through the switches S_{1L} and S_{1R} and Q_{2L} and Q_{2R}. Therefore, the electrical energy of the battery cell B₁ is transferred and stored into the inductor Ls.

When the weak cell is coupled to the inductor Ls through the switches in the release mode after the strong cell is coupled to the inductor Ls through the switches in the collect mode, a dead time is needed between the collect mode and the release mode.

The second mode t₁-t₂ is a mode for forming an electrical energy circulation path during the dead time. For this operation, the control unit turns on the switches Q_{1L} and Q_{1R} and Q_{3L} and Q_{3R} of the electrical energy transfer unit 44. Therefore, as illustrated in FIG. 12B, the collected electrical energy free wheels in a closed loop including the switches Q_{1L} and Q_{1R} and Q_{3L} and Q_{3R} and the inductor Ls during the dead time.

The third mode t₂-t₃ is a mode for transferring the collected electrical energy to the battery cell B₃ serving as the weak cell. For this operation, the control unit turns on the switches S_{3L} and S_{3R} of the first access unit 42, the switches S_{4L} and S_{4R} of the second access unit 43, and the switches Q_{1L} and Q_{1R} and Q_{4L} and Q_{4R} of the electrical energy transfer unit 44 by outputting the switch control signal to the switches. Thus, as illustrated in FIG. 12C, the electrical energy stored in the inductor Ls is transferred to the battery cell B₃ through the switches Q_{1L} and Q_{1R} and Q_{4L} and Q_{4R}.

While the first to third modes are repeated within one preset cycle, the voltage levels of the strong cell B₁ and the weak cell B₃ are equalized.

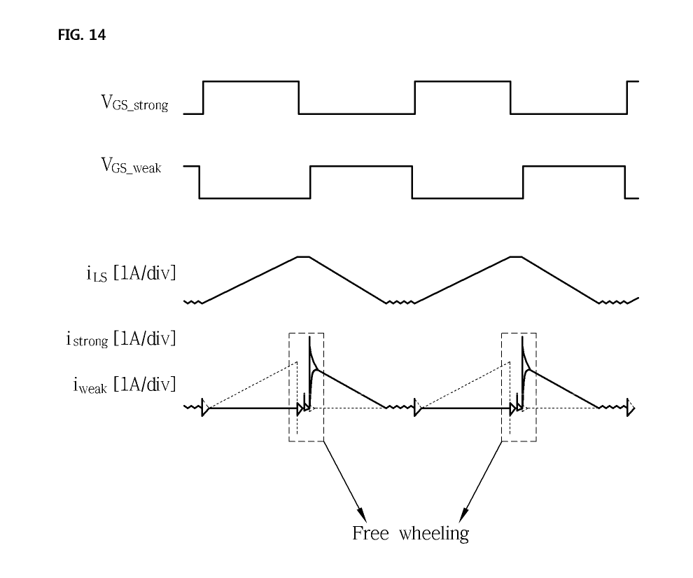

FIG. 14 is a waveform diagram illustrating test results of the battery cell balancing circuit 40 according to the present embodiment. That is, FIG. 14 illustrates results obtained by measuring a current which is outputted from a strong cell and supplied to the single inductor Ls through the switches of the access units and a current which is outputted from the single inductor Ls and supplied to a weak cell through the switches of the access units, in the balancing operation mode for supplying electrical energy stored in an even-numbered battery cell to another even-numbered battery cell. Referring to FIG. 14, the current of the strong cell is stored in the single inductor Ls and free wheels in the electrical energy transfer unit 44 during the dead time, in the collect mode. Furthermore, the electrical energy stored in the single inductor Ls is transmitted to the weak cell in the release mode.

For reference, there is a conventional LC resonant circuit corresponding to the technique for supplying and releasing electrical energy required for the battery cell balancing operation using the inductor Ls according to the present embodiment, and differences therebetween are as follows.

The conventional LC resonant circuit stores electrical energy during a half cycle of LC resonance, and releases the stored electrical energy during the other half cycle. In this case, a balancing circuit can be normally operated only when zero current switching (ZCS) is performed in synchronization with a resonant frequency set by an LC device value. At this time, balancing power depending on the element value is fixed. Furthermore, the conventional LC resonant circuit requires a ZCS sensing circuit and a control circuit having a complex structure. Therefore, the battery cell balancing circuit becomes complex, while the price thereof increases.

However, the battery cell balancing circuit using a single inductor according to the present embodiment does not require a ZCS sensing circuit, and can accurately transfer desired balancing power through duty and frequency control.

Furthermore, there is a conventional battery cell balancing circuit using a transformer having primary and second coils wound therearound. The conventional battery cell balancing circuit has the following differences from the present embodiment.

When electrical energy is transferred between different parities, electrical energy stored in the transformer is just transferred to a weak cell. However, when electrical energy is transferred between the same parties, electrical energy stored in the primary coil of the transformer is transferred to the secondary coil and then transferred to a weak cell. However, during this transfer process, a voltage spike is formed by leakage conductance of the transformer. Therefore, as the amount of transferred electrical energy is increased, the voltage spike may become higher. Thus, when balancing power is high, a voltage spike exceeding the range of an active element used herein may occur to break down the circuit. Therefore, the balancing power cannot be set to high power.

On the other hand, since the battery cell balancing circuit according to the present embodiment uses the single inductor Ls, the battery cell balancing circuit has a smaller size than the conventional battery cell balancing circuit using the transformer, and does not cause a voltage spike while transferring energy. Thus, balancing power can be set to high power.

According to the embodiment of the present invention, the battery cell balancing circuit can perform battery cell balancing by selectively connecting a strong cell or weak cell to the single inductor through the access units, thereby improving the efficiency.

Furthermore, since the battery cell balancing circuit transfers balancing energy through the single inductor, the cost and size of the balancing circuit can be reduced.

While various embodiments have been described above, it will be understood to those skilled in the art that the embodiments described are by way of example only. Accordingly, the disclosure described herein should not be limited based on the described embodiments.

What is claimed is:

1. A battery cell balancing circuit using a single inductor, comprising:
a battery pack having a plurality of battery cells connected in series;
a first access unit having access paths connected between a first common node and negative terminals of odd-numbered battery cells in the battery pack;
a second access unit having access paths connected between a second common node and negative terminals of even-numbered battery cells in the battery pack; and
an electrical energy transfer unit having a single inductor and a plurality of transfer paths, in order to temporarily store electrical energy collected or supplied through the first and second common nodes and then transfer the stored electrical energy,
wherein the plurality of transfer paths comprise:
a first transfer path having a pair of switches connected in series between the second common node and a third common node;
a second transfer path having a pair of switches connected in series between the first common node and the third common node;
a third transfer path having a pair of switches connected in series between the second common node and a fourth common node; and
a fourth transfer path having a pair of switches connected in series between the first common node and the fourth common node.

2. The battery cell balancing circuit of claim 1, wherein each of the access paths of the first and second access units comprises a pair of switches connected in series.

3. The battery cell balancing circuit of claim 2, wherein each of the switches comprises one of a metal oxide semiconductor field effect transistor (MOSFET), a bipolar junction transistor (BJT) and an insulated gate bipolar transistor (IGBT).

4. The battery cell balancing circuit of claim 3, wherein the switch is connected in parallel to a diode.

5. The battery cell balancing circuit of claim 1, wherein each of the switches comprises one of a MOSFET, a BJT and an IGBT.

6. The battery cell balancing circuit of claim 5, wherein the switch is connected in parallel to a diode.
